(19) United States
(12) Patent Application Publication
(10) Pub. No.: US 2005/0237932 A1
(43) Pub. Date: Oct. 27, 2005

(54) Method and system for rate-controlled mode wireless communications

(76) Inventor: Jung-Tao Liu, Madison, NJ (US)

Correspondence Address: JONES DAY, 222 EAST 41ST ST, NEW YORK, NY, 10017, US

(21) Appl. No.: 10/831,568

(22) Filed: Apr. 23, 2004

(51) Int. Cl. H04B 7/216; H04L 1/00; H04J 1/16; H04J 3/14; G06F 11/00; H04L 12/26; G01R 31/08; G08C 15/00; H04B 7/00

(52) U.S. Cl. 370/230; 370/252; 370/310

(57) ABSTRACT

A method and system is described that flexibly and efficiently adjusts uplink data transmission rates in a wireless communication system. In particular, a transport format limit indicator (TFLI) indicating the allowed changes to available transport formats, including, for example, the maximum allowed uplink data transmission rate, is sent by a network node to a user equipment, without a prior request from the user equipment for such information. The user equipment may then adjust its uplink rate based on the TFLI when desired without having to make a request for rate information from the network node.

### FIELD OF THE INVENTION

The present invention relates to uplink packet scheduling in wireless communication, and more particularly to signaling supporting dynamically adjusted high speed packet delivery and redelivery.

### BACKGROUND OF THE INVENTION

In a cellular network, a geographical area is covered by a plurality of cells. Each cell has a base station that communicates with, and regulates, a plurality of wireless devices, referred to herein as “user equipment” (UE). The base station is sometimes referred to herein as Node B. Wireless communications may conform to various wireless protocols. Of particular interest is the code division multiple access (CDMA) protocol since it provides advantages over other protocols such as increased system capacity.

So called third generation systems are being developed to promote wireless connectivity for voice, text and data services based on packet-based connectivity. In these third generation systems, Universal Mobile Telecommunications System (UMTS), a radio network using Wideband Code Division Multiple Access (WCDMA), is expected to provide 384 kilobits per second (kb/s) to 2 Megabits per second (Mbps) data transmission rates. This broadband multimedia communications system will potentially integrate the infrastructure for mobile and fixed communications with circuit-switched as well as packet-switched services. It would also support mixed media traffic and bandwidth-on-demand. Additional UMTS related information is available at http://www.3gpp.org/ftp/Specs/2003-06.

The UE and the base station also exchange information to establish a desirable rate of data transmission. Moreover, control information, typically transmitted in quadrature with the data, provides information for properly interpreting the data frames being sent by the UE.

In UMTS, available transport formats are typically arranged in the form of a tree such that a particular UE is allowed to use formats that are children of a specified node in the transport format tree. Thus, moving up the tree makes many more nodes, each representing a particular format specifying rate and other particulars, available.

UMTS permits dedicated logical channels to be set up for a particular UE to transmit its data and control information to the base station. Efficient use of dedicated channels requires ongoing adjustments to data transmission rates in order to improve data throughput. For example, transmission rates may be lowered when the data to be transmitted by the UE is insufficient to the keep the channel busy or increased when data to be transmitted exceeds the rate at which it is actually being transmitted. In addition, transmission errors, such as missing or corrupted data packets, must be detected and the data must be either recovered, if possible, or retransmitted. In UMTS, these functions are carried out by a hybrid automatic repeat request (HARQ) entity, which is a part of the protocol stack in both the transmitting and receiving devices.

In the transmitting device, the HARQ entity detects whether a transmitted packet has been properly received, and determines whether a retransmission is required. In the receiving device, the HARQ entity automatically signals to the transmitting device the successful receipt of a packet, organizes the received packets in the proper sequence and forwards them to the higher layers in the protocol stack for further processing. The receiving HARQ entity also automatically detects and signals defective or missing packets. Since the higher layers expect packets to be sequentially ordered, defective or missing packets may delay the delivery to the higher layers of subsequently received packets.

Published Patent Application No. U.S. 2003/0219037 A1, assigned to Nokia Corporation, describes a system using distributed signaling for uplink transmission rate control. The application describes a channel through which a UE can request an increase or decrease in the uplink transmission rate from Node-B in a message sent over a dedicated uplink channel. In response a rate control signal from Node-B is sent over a dedicated downlink channel to change the uplink transmission rate. This described system requires multiple transactions between a UE and a network node for adjusting the uplink data rates, which transactions both consume bandwidth and slow down the dynamic adjustment of the channel capacity in providing broadband connectivity.

The prior art rate control mechanisms do not allow sufficiently flexible control to enable a UE to select a rate better suited for its available power, or its data buffer, or even avoiding excessive errors. Moreover, the prior art uses dedicated channels for the uplink and downlink communications, which is more resource intensive than using shared channels.

There is a need, for a mechanism for uplink transmission rate adjustment that dynamically takes into account not only the network conditions, but also the condition of the UE and a network node, such as Node-B, to balance local and non-local factors in setting an uplink transmission rate. There is further a need for a fast uplink signaling scheme where a servicing node, e.g., a base station or Node-B, is capable of transmitting rate adjustment information with reduced bandwidth and other resource requirements.

### SUMMARY OF THE INVENTION

The present invention provides a method and system for flexibly and efficiently adjusting uplink data transmission rates. In particular, the invention disclosed herein overcomes the drawbacks of the prior art. The various embodiments of the invention are particularly useful in facilitating efficient wireless based links that can flexibly handle data flow rates large enough to support not merely voice or text based services, but also multimedia services. This flexibility results from allowing local details, such as a UE's condition and state, the network conditions and network node capabilities to be taken into account in selecting an uplink transmission rate. The base station as part of its communication protocol with a UE and without necessarily any request from the UE for transmission-rate information, transmits to the UE information regarding the change in the maximum allowed uplink data transmission rate. A UE can then select an actual uplink data transmission rate bounded by the maximum rate, taking into account its own context, such as data awaiting transmission to the base station, the rate at which data is being accumulated for transmission to the base station, available power for transmission of data to the base station, a tolerable error rate, and the like.

In one aspect of the invention, the data packets from the UE are sent over an enhanced uplink-dedicated physical data channel (EU-DPDCH) while control information regarding the data packets is sent over an enhanced uplink-dedicated physical control channel (EU-DPCCH). This provides high data rates in accordance with high speed direct packet access (HSDPA). Downlink communications are over a shared channel. Examples of a shared control channel include an enhanced uplink-response control shared channel (EU-RSCCH) and an enhanced uplink-shared control channel (EU-SCCH).

In accordance with a method of the present invention, a network entity, such as Node-B, transmits to the UE one of an acknowledge (ACK) and a non-acknowledge (NAK) signal to confirm receipt of a previously transmitted packet. This acknowledgement or lack thereof is sent with a transport format limit indicator (TFLI) signal on a shared response channel. The TFLI signal does not command the UE to lower or increase its uplink transmission rate. Instead, the UE interprets the TFLI signal, in combination with the ACK and NAK signals, as a change (e.g., increase or decrease), or lack thereof, in its maximum allowed uplink transmission rate.

In the WCDMA context, the UE can use the TFLI signal to determine the node in the transport format combination (TFC) that specifies the allowed transport formats. In general, in accordance with the present invention, the ACK/NAK and TFLI signals can be used to specify the range of available formats among any predetermined navigable specification of transport format tree. This information enables the UE to determine whether a prior transmission of a packet to the network entity was effective and flexibly adjust the transmission rate for subsequent communications. For example, if the transmission rate can be increased, i.e., the network entity is willing to receive additional packets at a higher transmission rate, then the TFLI signal may be set to 1 to indicate such a possibility. Similarly, if the previous packet was not received by the network entity, then the TFLI signal may indicate a lowering of the permissible uplink transmission rates available to the UE. Thus, the UE uses, possibly in conjunction with other factors, the TFLI, ACK and NAK signals sent by, for example, Node-B to adjust its uplink transmission rate.

The UE, may select the actual uplink transmission rate based on the allowed formats and at least one of the status of a MAC-EU-rc buffer, which is a buffer with data intended for transmission to the base station, and available power for transmission of signals. In some embodiments, the UE may also take into account its tolerance for errors in the transmission and reception of signals in selecting a particular data rate. A retransmit indicator identifies a retransmitted packet.

In one embodiment of the invention, the TFLI signal is sent in an enhanced uplink-rate control signaling channel (EU-RCSCH) subframe to the UE. The TFLI signal may, for example, occupy one bit to indicate that the uplink transmission rate may be either increased or left unchanged on the one hand or that it needs to be decreased on the other hand.

In one embodiment, the HARQ entity in the Node B may respond to the detection of a corrupted packet by sending a TFLI signal and a NAK signal to a UE over a shared control channel. The TFLI signal may lower a limit on uplink transmission rates available to the UE for a subsequent retransmission of the data in the packet since such a reduction may improve the likelihood of successful reception of the packet. The UE may also undertake other measures to improve transmission of the packets, such as increasing its transmission power or change its location, which may improve the received signal quality.

The HARQ entity in the Node B may respond to the successful receipt of a packet by sending to the UE an ACK signal and a TFLI signal to allow an increase in the highest available uplink transmission rate.

An apparatus in accordance with the present invention may be compliant with Release 5 or later of the W-CDMA specification.

These and other aspects of the invention are further described below with the aid of the following illustrative figures.

### DESCRIPTION OF THE ILLUSTRATIVE FIGURES

FIG. 1 is an illustrative UMTS compliant system in which the present invention is implemented.

FIG. 2 is an illustrative handshaking interaction between a UE and Node-B in accordance with the present invention.

FIG. 3 is an illustrative timing diagram showing transmission of packets with AK and NAK responses coupled with TFLI in an embodiment of the present invention.

FIG. 4 is an illustrative method in accordance with an embodiment of the present invention for retransmission of a data packet.

FIG. 5 is an illustrative method in accordance with an embodiment of the present invention for transmission of data with a HARQ implementation ensuring receiving of uncorrupted packets.

FIG. 6 is an illustration of a WCDMA compliant system in accordance with an embodiment of the present invention in which buffered corrupted packets are combined to recover a potentially corrupted packet.

FIG. 7 is a block diagram illustrating the interactions between the HARQ and the physical layer in accordance with an exemplary embodiment of a network node.

FIG. 8 is a block diagram illustrating the interactions between the HARQ and other components of an exemplary embodiment of an User Equipment.

### DETAILED DESCRIPTION OF THE INVENTION

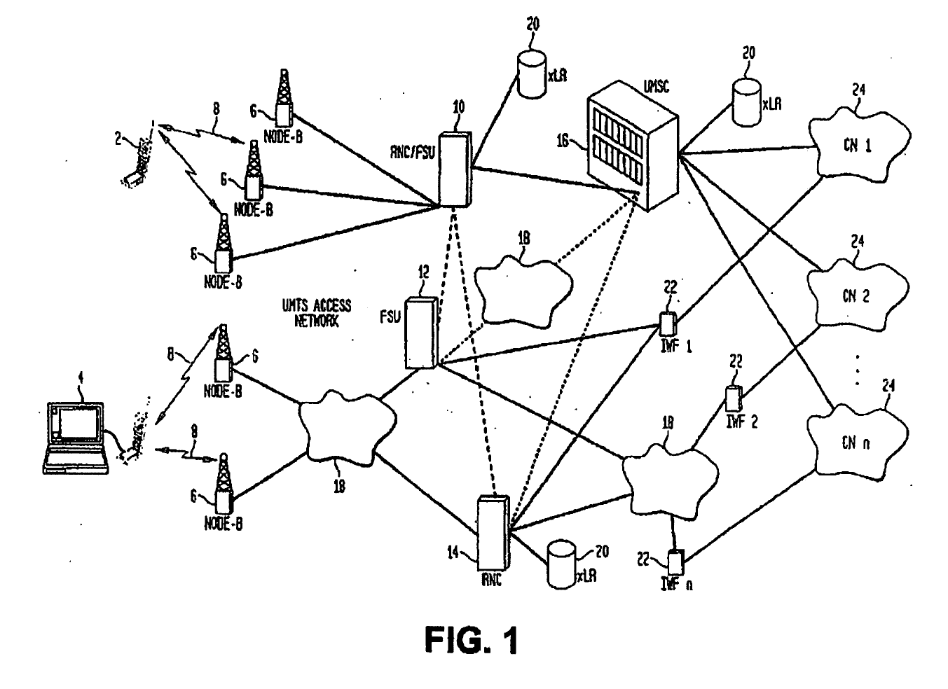

The methods and systems described herein may be implemented using software and hardware, individually or as a combination. FIG. 1 is an illustrative block diagram of an UMTS network implementing an embodiment of the invention. A plurality of user equipment (UE) 2 and 4, e.g., mobile terminals, communicate with base stations 6 via CDMA wireless link 8. These base stations communicate with a network component, Radio Network Controller (RNC) 14, that provides radio resources management functions. In UMTS, soft handoffs are supported so that a particular UE does not experience a disruption when one base station hands over communications to another base station. Soft handoffs allow a base station to communicate with two or more base stations 6 with a frame selector unit (FSU) 12, connected to both the base stations, comparing the frames received by two base stations 6 to identify the better frame. This makes it possible for two (or more) base stations to seamlessly support a single UE.

An FSU may be physically integrated with the RNC, e.g., block 10 in FIG. 1. Other elements illustrated in FIG. 1 perform conventional functions. xLR databases 20 provide home and visiting location information. A Universal Mobile Switching Center (UMSC) 16 serves as the mobile switching center for the base stations 6 in UMTS. Sub-networks 18 are wireless service provider networks, which may be encountered by UEs in connecting to core networks 24.

FIG. 1 also shows the connection between a mobile wireless device and a core network. UE 2 communicates via an air interface, i.e., wireless communication, with a UTRAN (UMTS terrestrial radio access network) compliant Node-B 6 (also termed a base station). Node-B 6, in turn, communicates with, e.g., RNC/FSU 10, which communicates with core network entity 24 via UMSC 16.

Uplink signaling by a wireless terminal to a Node-B for high-speed downlink packet access (HSDPA) typically conveys hybrid automatic repeat request (HARQ) related information and channel quality feedback. The inevitable air interface in wireless communications makes the efficient and accurate recovery of transmitted packets a challenge. The reliability of data transmission may be improved in newer-generation CDMA systems by HARQ.

HARQ reduces errors by causing retransmission of packets that are determined at the receiver to be corrupted or missing. In W-CDMA Release 5, the Medium Access Control (MAC)-hs sublayer residing on top of the physical layer includes HARQ. Typically, a HARQ entity at the transmitter processes data into packets having sequential transmission sequence numbers (TSNs) corresponding to the sequential order in which they are then transmitted to the receiver, for instance, UE 2, 4 for a downlink transmission, or Node-B 6 for an uplink transmission.

At the receiver, a corresponding HARQ entity attempts to recover each transmitted packet while detecting corrupted or missing packets. Corrupted packets may be buffered for further processing. Upon detection of a missing or corrupted packet, a negative acknowledgment (NAK) is automatically sent from the receiver to the transmitter to initiate a retransmission of the corrupted or missing packet.

The receiver HARQ entity provides the recovered packets (i.e., those decoded correctly) to higher layers. Typically, the higher layers expect ordered data. Since packets may be recovered out-of-order at the receiver, packets are re-ordered and buffered prior to providing the packets in the proper order, as they become available, to higher layers.

Communications between the UEs and base stations may be conducted over shared or dedicated channels, or a combination thereof. Examples of shared channels include the broadcast channel (BCH), paging channel (PCH) and the random access channel (RACH), the enhanced uplink-rate control signaling channel (EU-RCSCH), and the enhanced uplink-shared control channel (EU-SCCH), and others. EU-SCCH is described in greater detail in the co-pending patent application that is also assigned to the assignee of this application, and is identified by Ser. No. 10/649,088, which application is incorporated herein by reference.

Nonexhaustive examples of dedicated channels, which may be assigned for use by specific UE in a downlink and/or uplink directions, include the dedicated physical data channel (DPDCH), high-speed-dedicated physical data channel (HS-DPDCH), enhanced uplink-dedicated physical data channel (EU-DPDCH), dedicated physical control channel (DPCCH), high-speed-dedicated physical control channel (HS-DPCCH), enhanced uplink-dedicated physical control channel (EU-DPCCH), and others. UE 2 in FIG. 1 uses EU-DPCCH and EU-DPDCH for transmitting data to base station 6.

The uplink DPCCH is used to carry control information generated at layer 1 (the physical layer, PHY) of the protocol stack, including known pilot bits for channel estimation for coherent detection, transmit power-control (TPC) commands, feedback information (FBI), and the optional transport-format combination indicator (TFCI).

In one embodiment of the invention, in a rate-controlled mode, a UE 2, 4 selects an uplink transmission rate from the current allowed transport format combination system (TFCS) in order to initiate uplink transmissions. This selection may be based on one or more of the current buffer size, the available power, and the desired/tolerable error rate with hybrid automatic response request functionality. The available transmit power for communicating over EU-DPDCH may be determined from a stored table. Typically, the table entries exhibit a one-to-one correspondence between the available uplink transmission rates and the selected transport format. Thus, selection of a transmission format also determines the uplink transmission rate. Packet data is carried over EU-DPDCH with the associated EU-DPCCH in the rate-controlled mode.

At the receiver, base station 6 decodes the EU-DPCCH, while buffering the concurrently received data over EU-DPDCH. After a fixed period of time, for example three time intervals, base station 6 transmits either an ACK (acknowledge) or a NAK (not acknowledge) signal.

In the present invention, along with the ACK/NAK signals, Node-B transmits a transport format limit indicator (TFLI) signal. The TFLI signal contains information about the adjustments to the maximum uplink transmission rate that is available to UE 2 for communicating with Node-B over an EU-RCSCH.

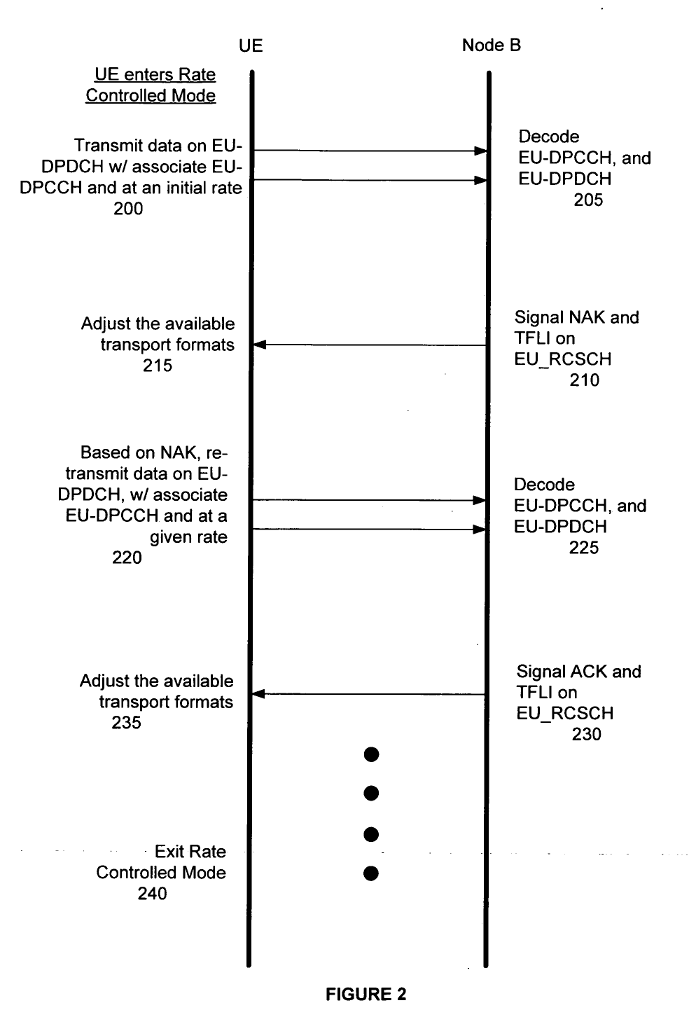

The hand-shaking protocol for a rate-controlled mode between a Node-B and a UE is illustrated in FIG. 2. A rate-controlled mode, as used herein, is a mode in which the rate for uplink data transmissions are set at both the network node and the user equipment with the aid of ACK/NAK and TFLI signals sent by the network node to the user equipment. Actions or events at the UE are shown on the left hand side of FIG. 2 and the events/actions at the Node-B on the right hand side. At the left hand top of FIG. 2, the UE enters a rate-controlled mode. At step 200, the UE transmits data on EU-DPDCH and associated control data on EU-DPCCH at an initial data rate. At step 205, these transmissions are received at Node-B, which decodes the EU-DPDCH and EU-DPCCH transmissions. At step 210, the Node-B sends back an ACK/NAK and a TFLI signal on EU-RCSCH, which is a shared channel. The ACK/NAK signal may be one bit. The TFLI signal may also be a single bit. It may also be more than one bit. The present invention is not limited to the number of bits in the TFLI signal.

At step 215, in response to receiving the NAK signal and the TFLI signal, the UE may adjust the available transport formats, which may include the uplink transmission rate and/or block size, for the next transmission. Node-B may learn of the actual uplink transmission rate from the UE transmissions themselves. This information may be part of the control information or may be determined in the course of decoding, the control information, which is sent over EU-DPCCH. At step 220, if a NAK was received, the UE retransmits the data over EU-DPDCH and EU-DPCCH at a given rate selected among the available transport formats. In addition, a signal (NDI set to 0) is transmitted indicating that this is a retransmission of a previously sent packet. Certain embodiments may also signal the sequence or other identifying number of the unacknowledged packet.

At step 225, the Node-B receives the retransmission and decodes it. At step 230, it then sends back an ACK/NAK signal and a TFLI signal on EU-RSCCH. It should be noted that while the actual uplink transmission rate may not exceed prescribed limits, the UE may select a lower value, for instance, for a desired Quality of Service or in view of its power resources and MAC-EU-rc buffer status.

UE may then transmit a new packet, if any. At step 235, the UE again decides if a readjustment to its uplink transmission rate is desired based on the interactions with the Node-B. After several such, although not identical exchanges and associated adjustments to the uplink transmission rate, the UE quits the rate-controlled mode at step 240.

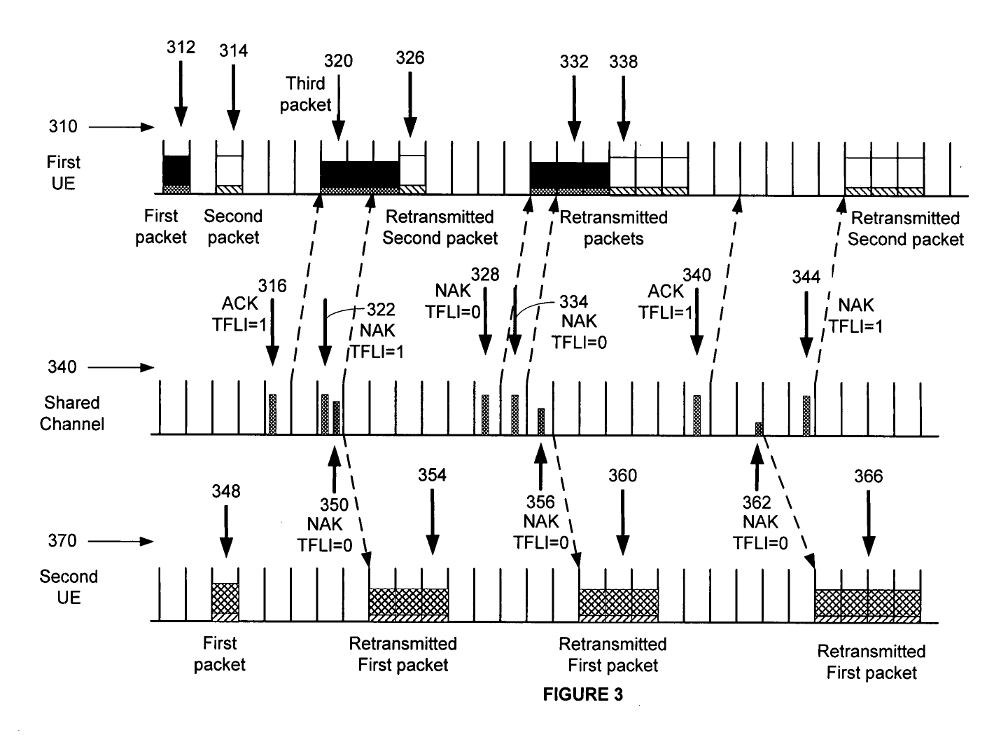

FIG. 3 is an illustrative timing diagram for rate-controlled mode operations with variable length transmission time intervals. Each time slot may be, for example, 2 ms long. The round-trip propagation time delays are not shown for clarity. Three different interactions are shown in the context of two UEs to illustrate the use of TFLI and ACK/NAK signals in changing the uplink transmission speed in view of success, sporadic success or continued failure to satisfactorily transmit data packets. The illustrated adjustments are by way of changing the available formats or reducing the transmission speed to improve the likelihood of signal reception. These illustrative interactions should not be interpreted as limitations on the scope of the present invention, but rather as illustrating possible dynamic responses and adjustments to efficiently transmit uplink data.

In FIG. 3, numerals identify particular time points. The processing time for the EU-DPDCH and the EU-DPCCH is assumed, for the purpose of this illustration only, to occupy three time slots at Node-B while the processing time (at the UE) for information carried via the EU-RCSCH is assumed to require one time slot. As will be readily appreciated by one having ordinary skill in the art, this should not be interpreted to be a limitation, since it is merely a convenient assumption for illustrative purposes.

In FIG. 3, central channel 340 depicts downlink control communications from Node-B to two UEs (UE1 and UE2) over a shared channel. UE1 uses enhanced uplink-dedicated physical channel EU-DPCH 310 (control and data) assigned to it while UE2 uses another enhanced uplink-dedicated physical channel EU-DPCH 370 (control and data) assigned to it. As shown in FIG. 3, UE1 sends its first packet at time 312 and a second packet at time 314. UE2 sends its first packet at time 348. Each of the packet transmissions is shown to include two parts, the top portion depicts the data while the bottom portion is the associated control information. Both are sent concurrently.

Next, Node-B responds at time 316 to the first data packet sent by UE1 at time 312 with an ACK signal and a TFLI value of 1, which results in no change in the maximum permitted uplink transmission rate at UE1. UE1 transmits a new third packet, indicated by a New Data Indicator (NDI) set to 1, at time 320. At time 322, Node-B responds to it with a NAK signal and a TFLI signal value of 1. At time 326, at UE1, this results in a change in the range of available formats at UE1, for example, being increased by a predetermined increment to allow a greater range of uplink transmission speeds to UE1. It should be noted that different implementations of Node-B and UE will have different rules for changing formats and responding to even the same ACK/NAK and TFLI signal values depending on the type of service particular providers seek to provide. Thus, this description is for the purpose of illustration only.

Node-B responds to the first packet sent by UE2 with a NAK and a TFLI value of 0 at time 350. UE2 is further away from Node-B (than is UE1) and communication with it accordingly takes longer as illustrated. In response, at time 354, UE2 decreases the available formats in a predetermined manner and retransmits the packet with the NDI set to 0 to indicate the retransmission. As is readily seen, at time 356, transmission from UE2 result in another set of NAK and TFLI=0 transmissions by Node-B. These, in turn, result in another retransmission at time 360 of the packet with NDI set to 0 to indicate the retransmission. This retransmission is made after another downward adjustment in the available formats by UE2. Node-B is still unable to satisfactorily receive the transmission from UE2. It sends, at time 362, yet another NAK and TFLI signal combination with TFLI having a value of ‘0’ to UE2 in the response to the retransmission at time 360. At time 366, UE2 retransmits, following another downward adjustment in the available formats, the packet with NDI set to ‘0’ to indicate the retransmission in response to a previous unsuccessful transmission.

Returning to the interactions between Node-B and UE1, the packet transmitted at time 320 and another transmission at time 326 by UE1 result in Node-B responding at times 328 and 334 respectively. Both of the response contain NAK and TFLI values of 0. UE1, then decreases the available formats and retransmits packets originally transmitted at times 320 and 326 at times 332 and 338 respectively. Notably, such downward adjustments increase the likelihood of a reduction in the uplink transmission rate selected by the UE1, although such a reduction is not required by Node-B in every case.

The packet sent by UE1 at time 332 is received in satisfactory condition by Node-B and an ACK signal with a TFLI setting of 1 is sent at time 340. UE1 does not send a new packet since its buffer is empty. However, the packet sent by UE1 at time 338 is corrupted as received by Node-B resulting in an NAK signal with a TFLI value of 1 being sent to UE1 at time 344. In response, UE1 increases its range of available formats and responds with a re-transmission at time 346 of the packet last sent at time 338.

The above-described method and system requires nominal bandwidth while enabling dynamic responses that are sensitive to the local environment and state of a wireless device, such as a UE, and the network condition and the state of a network entity, such as Node-B. Significantly, the UE does not have to request a change in the uplink transmission rate. Adjustments to the uplink transmission rates may be automatic and include the input of both the network node and the UTE.

As was previously mentioned, a UE is not allowed to select any rate for uplink transmissions above the limit set by the formats available in the transport format combination set for the UE. The available formats and, consequently, the available uplink transmission rates may be modified in response to the TFLI signal. Again, the TFLI may be, but is no necessarily, a single bit, but may be more. The rate selection by the UE is based on one or more of the MAC-EU-rc buffer status, the available power and an acceptable error rate with the use of hybrid automatic response request procedures.

The rate of a spreading code, which are employed in UMTS, is specified as a chip rate rather than a bit rate. The EU-RCSCH subframe may be synchronized in the manner described for the enhanced uplink-shared control channel (EU-SCCH), i.e., with a timing offset of (1280-T₀ mod 7680) chips from the start of the P-CCPCH frame boundary. This timing offset is employed regardless of whether the downlink communications include high-speed downlink packet access. The two control channels may provide two types of control information concurrently. Thus two types of control information, if present, can be sent via quadrature phase shift keying (QPSK) to ensure lack of latency between them and allow the receiver to make a choice based on the alternatives presented by the two types of control information. Similar considerations apply to data and control information for their handling.

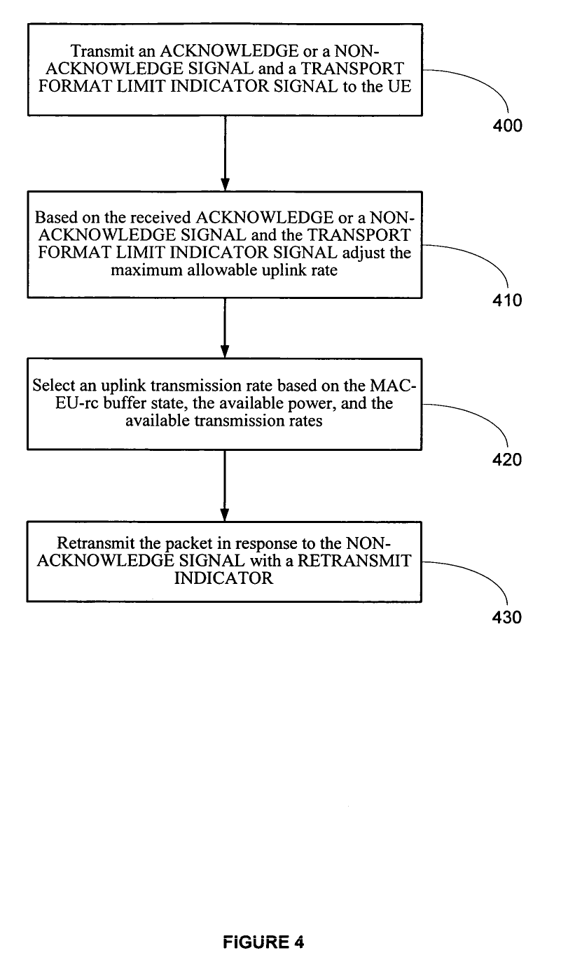

The invention includes a method for use by a node or other entity of a radio access network in communicating with UE in a rate-controlled mode so as to regulate an uplink transmission rate used by the UE in communicating with the entity of the radio access network. The method comprises, as shown in FIG. 4, transmitting, during step 400, typically by a serving node such as Node-B, to the UE an ACK or NAK signal and a TFLI signal over a shared response channel, such as an EU-RCSCH, conveying information regarding permissible uplink transmission rates available to the UE. During step 410, the TFLI and the ACK/NAK signals may be used by the UE to adjust the maximum allowed uplink transmission rate in a range or set of available uplink transmission rates.

The communication system supports a method for effecting retransmission of data by a hybrid automatic retransmission entity, comprising: transmitting a packet to a target entity; receiving an indication, such as an ACK or a NAK signal in response from the target entity over a shared control channel, such as an EU-RCSCH; receiving a TFLI signal from the target entity over the shared control channel; and re-transmitting the data to the target entity in response to receiving the NAK signal at an uplink transmission rate selected based on at least one of the transmit buffer state, the available power, and an acceptable error rate.

In this aspect of the invention, during step 420, the UE adjusts the uplink transmission rate based on at least one of a MAC-EU-rc buffer status and available power at the UE. The UE may also use other parameters, such as a specification for an acceptable error rate in choosing an uplink transmission rate within its allowed range. The different choices for interpreting TFLI and ACK/NAK signals result in allowing designs aimed at various degrees of responsiveness to user needs while taking into account the UE resources.

During step 430, if needed due to a NAK response from the network node, the data packet is retransmitted with an indicator, communicated via, for instance, a ‘new data indicator’ (NDI), that it is not a new packet, but is a retransmitted packet.

In one aspect of the invention, the TFLI signal may be sent in an enhanced uplink-rate control signaling channel (EU-RCSCH) subframe to the UE from Node-B. The TFLI signal may comprise one bit.

In one aspect of the invention, the uplink transmission rate may be lowered by the UE in response to a NAK signal. Non-acknowledged packet may then be sent again at the lower rate with a retransmit indicator. Further, the uplink transmission rate can be increased by the UE in response to receiving an ACK signal. However, these rules do not require that such lowering or raising of the uplink transmission rates depend only on the receiving an ACK or a NAK signal. Thus, for instance, the uplink transmission rate can be increased or left unchanged by the UE in response to receiving the acknowledgement of a packet transmitted by the UE along with a set TFLI from the target entity.

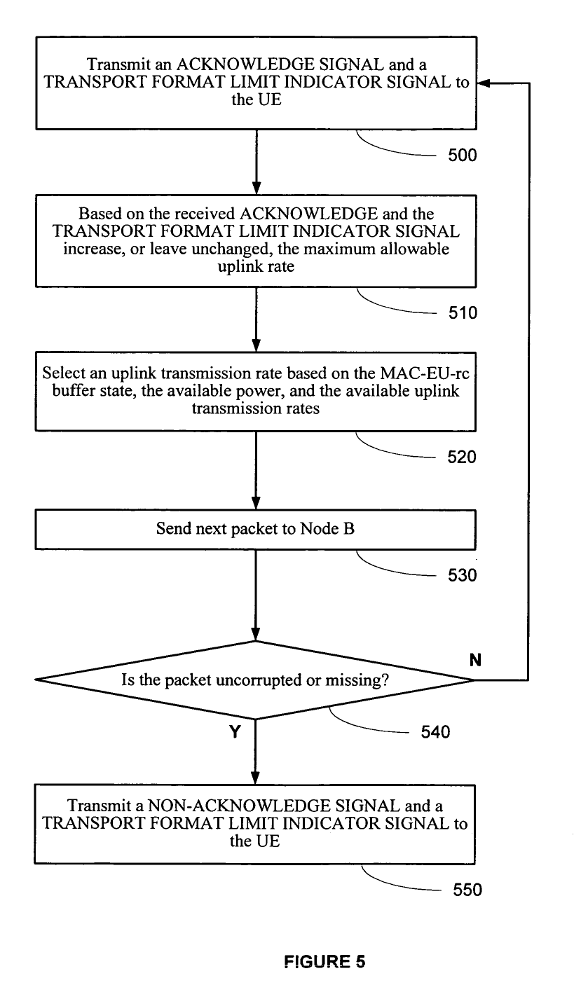

FIG. 5 is an illustrative method for increasing an uplink transmission rate by a UE in response to detecting sufficient data to transmit, sufficient transmission power, and prior successful retransmission of data packets. In FIG. 5 during step 500 an ACK signal is sent to a UE along with the TFLI signal. During step 510, the UE, based on the ACK and TFLI signals, increases (or leaves unchanged) its maximum allowable uplink transmission rate. During step 520, an uplink transmission rate for the next packet to be sent is selected based on at least one of a MAC-EU-rc buffer status and available power. The next packet is sent to Node-B during step 530 at the new uplink transmission rate.

At Node-B the received packet is evaluated during step 540 to determine if it is corrupted or missing with the aid of a HARQ entity. If the packet is corrupted, then control shifts to step 550, during which NAK and TFLI signals are sent by Node-B to the UE over a shared control channel. In one embodiment of the invention, the TFLI signal may be selected to lower a limit on available uplink transmission rates for a subsequent retransmission of the data in the corrupted packet. Alternatively, if the packet is not corrupted, then control shifts to step 500 for sending an acknowledgement. Advantageously, the value of the TFLI signal permits raising the limit on the available uplink transmission rates for a subsequent transmission.

The TFLI signal may use, in certain embodiments of the invention, as little as one bit in the transmission over the shared control channel to the wireless entity, such as an EU-RCSCH or an EU-SCCH. The data packets are sent by the wireless entity over an EU-DPDCH via an air interface, while the control information regarding the data packets may be sent over an EU-DPCCH to provide HSDPA compliant transmissions.

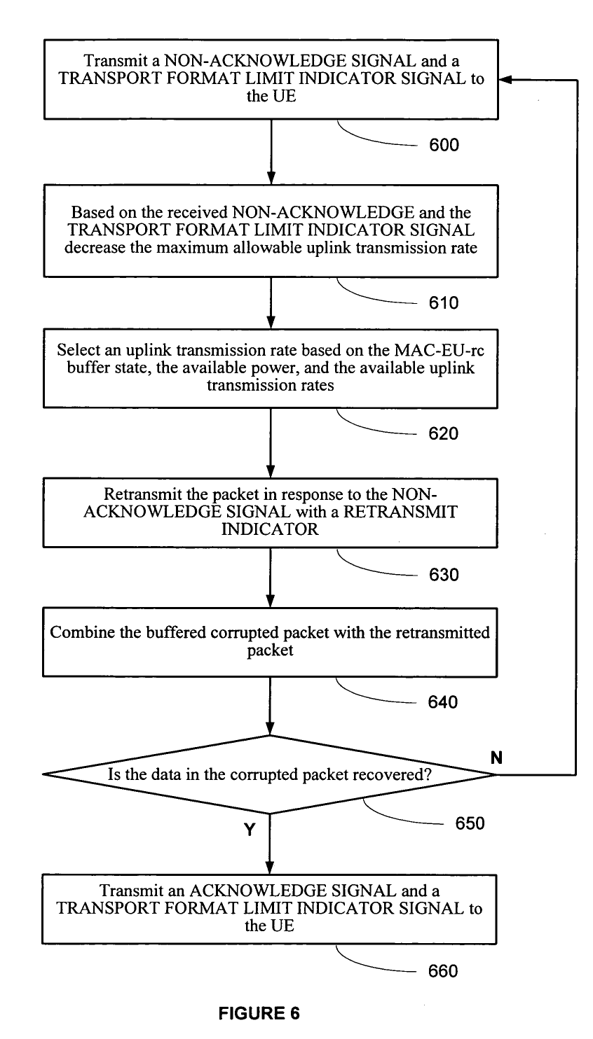

FIG. 6 illustrates a method for successful transmission of a data packet that is retrieved following with a previously transmitted corrupted packet. During step 600, a Node-B sends a NAK signal to a UE. The UE, during step 610, adjusts its range of available uplink transmission rates, and during step 620 selects a rate for the transmission of the next packet based on its condition. Then, during step 630, the packet that was received as corrupted by Node-B is retransmitted.

Upon receiving the retransmitted packet, as indicated by, for instance, a ‘0’ value for a NDI, it is combined with the buffered corrupted packet during step 640. During step 650, the buffered data is evaluated to determine if the packet data can be recovered with the reduced signal to noise ratio due to the combining of the results of two or more transmissions of the same packet data. If the packet data cannot be recovered, control flows back to step 600. Otherwise, upon recovery of the packet data, control flows to step 660, during which an ACK signal is sent to the UE.

The techniques described herein for improving high speed broadband wireless transmissions may be implemented by various hardware, software, or combinations thereof functioning as means for achieving a described function. The elements used to implement the techniques, e.g., the HARQ functionality for detecting a missing or corrupted packet, or an entity in a UE for sensing its power resources and MAC-EU-rc buffer may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described herein, or a combination thereof. For a software implementation, these techniques may be implemented with modules (e.g., procedures, functions, and so on) that perform the functions described herein. The software codes may be stored in a memory unit and executed by a processor (e.g., a programmable logic device). The memory unit may be implemented within the processor or external to the processor, in which case it can be communicatively coupled to the processor via various means as is known in the art. Thus, various functions described in the context of some illustrative means may be implemented in numerous combinations of the illustrative hardware and software recited above.

One embodiment of the invention is an apparatus supporting the hybrid automatic response request protocol comprising: means for detecting a defective, incomplete, or missing packet in a plurality of ordered packets received at a target entity via at least one air interface; means for buffering received complete packets ordered after the detected defective, incomplete, or missing packet while attempting to reconstruct the detected defective, incomplete, or missing packet; means for buffering the detected defective, incomplete, or missing packet; and means for automatically effecting retransmission of data in the detected defective, incomplete, or missing packet by generating a NAK signal and a TFLI signal; and means for sending the NAK signal and the TFLI signal to a source entity over a shared control channel, wherein the source entity is instructed to lower its uplink transmission rate in response to receiving the combination of the non-acknowledge signal and the TFLI signal.

Such an apparatus may further comprise: means for combining the buffered detected defective, incomplete, or missing packet with the retransmitted data in the detected defective, incomplete, or missing packet to recover the data in the detected defective, incomplete, or missing packet. The apparatus may also comprise: means for forwarding a plurality of ordered packets for processing; and means for automatically generating an ACK signal and the TFLI signal for transmission to the source entity over the shared control channel, wherein the source entity is permitted to increase its uplink transmission rate in response to receiving the combination of the generated ACK signal and TFLI signal. The apparatus may advantageously be compliant with Release 5 or later of W-CDMA specification.

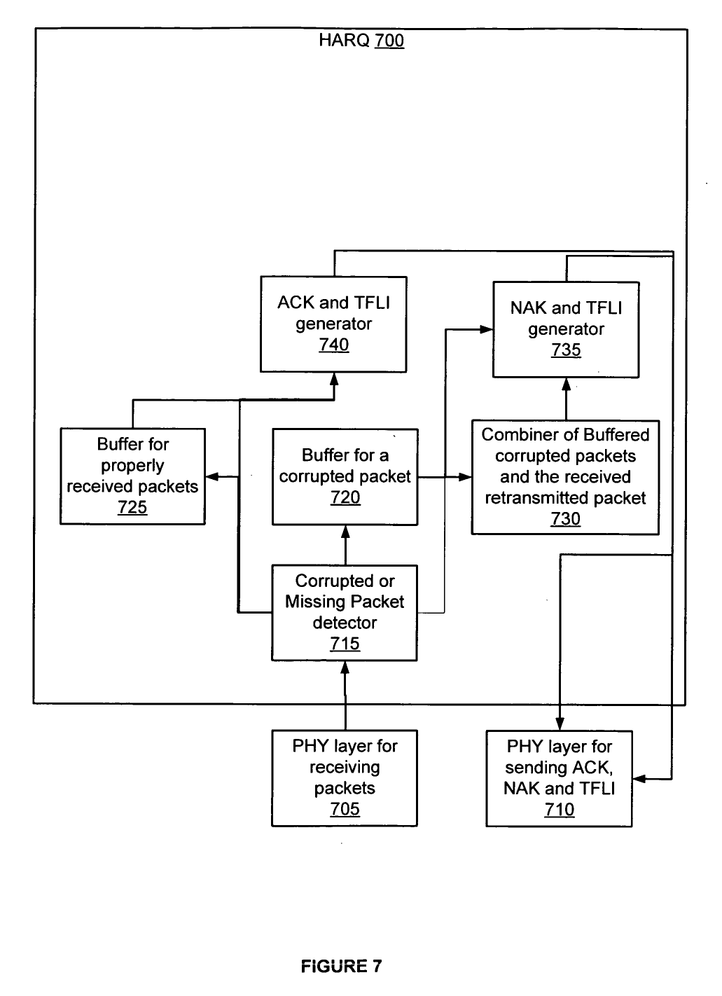

FIG. 7 is an illustrative implementation of a hybrid automatic response request entity at a Node B showing various means configured in an exemplary embodiment. HARQ 700 is in communication with PHY layer 705 for receiving and PHY layer 710 for sending packets. Received packets are checked for missing or corrupted content in module 715, which separately buffers corrupted packets in module 720 and complete packets in module 725. In addition, retransmitted packets are combined with buffered corrupted packets in module 730 to increase the likelihood of recovering data. In response to a failure in recovering data in a packet, a NAK signal is generated in module 735. Alternatively, upon receiving a corrupted packet that allows recovery of data, an ACK signal is generated in module 740.

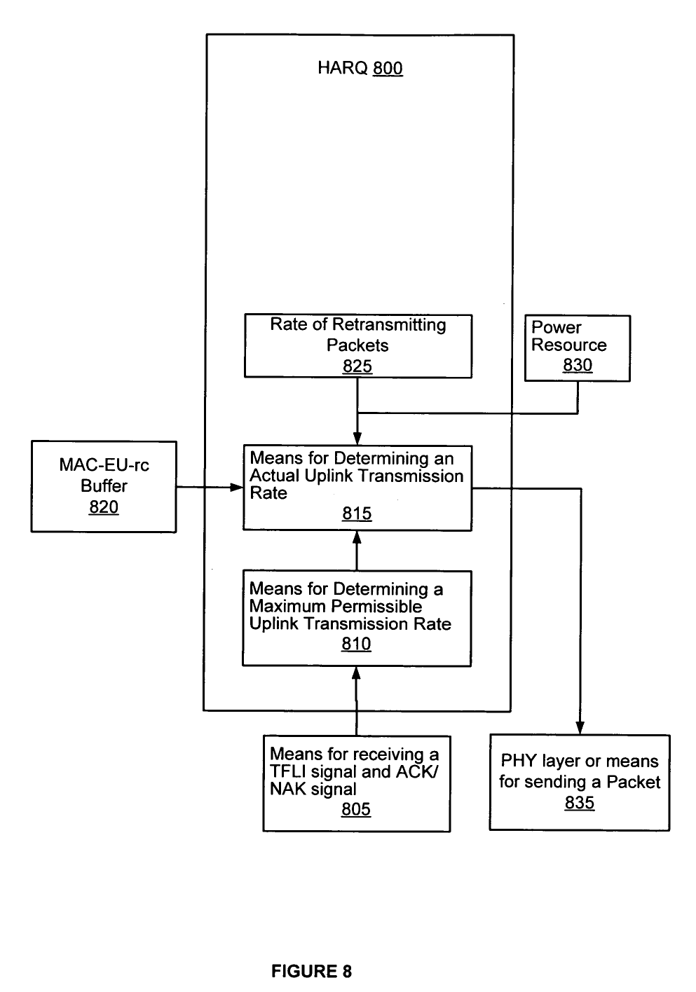

FIG. 8 is a block diagram illustrating the interactions between the HARQ and other components of a UE. HARQ 800 is in communication with means for receiving a TFLI signal 805 and the ACK/NAK signals, typically, via a PHY layer. Received TFLI and ACK/NAK signals are processed by means for determining a maximum permissible uplink transmission rate 810. This determination may differ between different implementations, e.g., to provide different quality of service levels. An actual rate for transmitting a packet on an uplink channel is determined by means for determining an actual uplink transmission rate 815. Means for determining an actual uplink transmission rate 815 arrives at an actual transmission rate based on one or more of a status of a MAC-EU-rc buffer 820, an acceptable error rate 825, and available power 830. Again particular choices and weights reflect a desired quality of service or similar service measure. Means for determining an actual uplink transmission rate 815 then communicates this actual transmission rate to the PHY layer 835 for sending packet(s) to the network node. The various means in the UE may be implemented in software, hardware or a combination of software and hardware.

It should be noted that the distinct modules of FIGS. 7 and 8 are shown for the purpose of illustration only, and some of the shown modules may be combined into a single physical device with no loss of generality.

The illustrative descriptions of the application of the principles of the present invention are to enable any person skilled in the art to make or use the disclosed invention. All references cited herein are incorporated by reference herein in their entirety. These descriptions are susceptible to numerous modifications and alternative arrangements by those skilled in the art. Such modifications and alternative arrangements are not intended to be outside the scope of the present invention. The appended claims are intended to cover such modifications and arrangements. Thus, the present invention should not be limited to the described illustrative embodiments but, instead, is to be accorded the broadest scope consistent with the principles and novel features disclosed herein.

1. A method for regulating an uplink transmission rate, the method comprising the steps of:
setting a transport format limit indicator signal based on available resources; and
transmitting, in response to a first received data packet, the transport format limit indicator signal indicating changes to available uplink transmission rates and at least one of an acknowledge and a non-acknowledge signal.

2. The method of claim 1, wherein the step of setting comprises setting the transport format limit indicator signal to reduce a maximum allowed uplink transmission rate in response to at least one of an excessive error rate, an increase in demand on resources, and a reduction in the available resources.

3. The method of claim 1, wherein the transport format limit indicator signal and the acknowledge or non-acknowledge signal are transmitted over a shared channel.

4. The method of claim 3, wherein the shared channel comprises at least one of an enhanced uplink-rate control signaling channel and an enhanced uplink-shared control channel.

5. The method of claim 1, wherein the transport format limit indicator signal comprises one bit.

6. The method of claim 1, wherein the transport format limit indicator indicates at least one of increasing, decreasing and leaving unchanged a current maximum allowed uplink transmission rate.

7. The method of claim 1 comprising:
determining that the first packet is missing or corrupted; and
wherein the step of transmitting comprises sending the first transport format limit indicator signal and the non-acknowledge signal.

8. The method of claim 7, wherein the first transport format limit indicator signal indicates a lowering of a limit on available uplink transmission rates for a subsequent retransmission of the first packet.

9. The method of claim 7 further comprising the steps of:
receiving a second packet;
determining that the second packet is acceptable; and
sending, in response, a second transport format limit indicator signal and the acknowledge signal, wherein the second transport format limit indicator signal indicates that a limit on the available uplink transmission rates for a subsequent transmission can be raised.

10. The method of claim 6 further comprising the steps of:
transmitting the first packet;
receiving, in response, the non-acknowledge signal, and the first transport format limit indicator signal; and
re-transmitting, the first packet in response to receiving the non-acknowledge signal.

11. An user equipment comprising:
an air interface for receiving a transport format limit indicator signal indicating permissible uplink transmission rates, and at least one of an acknowledge signal and a non-acknowledge signal;
means for determining a maximum permissible uplink transmission rate based on the transport format limit indicator signal, and one of the acknowledge signal and the non-acknowledge signal; and
means for determining an actual uplink transmission rate from available uplink transmission rates.

12. The user equipment of claim 1, wherein the means for determining an actual uplink transmission rate take into account on one or more of a status of a MAC-EU-rc buffer, an acceptable error rate, and available power.

13. The user equipment of claim 11, wherein the means for receiving receives the transport format limit indicator signal and the acknowledge or non-acknowledge signals over a shared channel.

14. The user equipment of claim 11, wherein the means for determining the maximum permissible uplink transmission rate lowers the maximum permissible uplink transmission rate in response to receiving the non-acknowledge signal and the transport format limit indicator signal.

15. The user equipment of claim 11, wherein the means for determining the maximum permissible uplink transmission rate raises the maximum rate in response to receiving the acknowledge signal and the transport format limit indicator signal.

16. A system comprising:
a shared control channel,
means for automatically generating a transport format limit indicator signal indicating permissible uplink transmission rates and at least one of a non-acknowledge signal and an acknowledge signal; and
means for transmitting the transport format limit indicator signal and the at least one of the non-acknowledge signal and the acknowledge signal over the shared control channel

17. The system of claim 16 comprising:
means for detecting a corrupted packet in a plurality of received packets;
means for buffering packets that are received subsequent to the corrupted packet;
means for recovering the data in the corrupted packet by improving upon a signal to noise ratio based on buffered previously received one or more corrupted packets; and
means for automatically generating the acknowledge signal and the transport format limit indicator signal in response to successful recovery of the data in the corrupted packet.
